(19) United States
(12) Patent Application Publication
(10) Pub. No.: US 2010/0001044 A1
(43) Pub. Date: Jan. 7, 2010

(54) Full penetration weld joint

(75) Inventors: Danny L. Weibling, Metamora, IL (US); Stuart R. Schmidgall, Tremont, IL (US); Mark J. Roeder, St. Martin d'Uriage (FR)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/168,550

(22) Filed: Jul. 7, 2008

(51) Int. Cl. B23K 31/02; B32B 3/02

(52) U.S. Cl. 228/164; 428/583

(57) ABSTRACT

A weld joint adapted to facilitate butt-welding attachment of a first structure to a second structure. The weld joint includes a first J groove disposed across a first side of the weld joint and a second J groove disposed across a second side of the weld joint opposing the first side. A land-projection segment extends away from an intersection of chamfered groove faces across the first structure. The first J groove and the second J groove cooperatively define a substantially K-shaped joint profile.

### TECHNICAL FIELD

This patent disclosure relates generally to weld connections and, more particularly, to weld joint constructions adapted to promote strength in full-penetration welds.

### BACKGROUND

Welding is a generally known method for joining metal structures by heating the structures to temperature along a connective interface. In many instances, a filler metal forming a weld bead may be introduced along the interface. The process may be carried out manually or using automated equipment such as robotic welders and the like. By way of example only, and not limitation, various welding processes include Shielded Metal Arc Welding, Laser Welding, Gas Tungsten Arc Welding, and Gas Metal Arc Welding. Laser Welding and Gas Tungsten Arc Welding may be particularly useful in producing so-called “Full Penetration Welds” in which a fully welded interface is formed between two parts.

In many instances, it may be useful to adjoin structures in abutted orientation to one another. Such weld constructions are commonly referred to as butt-welds. In performing a butt-welding operation it may be desirable to machine or otherwise contour the interface surface of one or both parts prior to welding in order to provide a joint geometry which promotes weld strength.

By way of example only, and not limitation, one exemplary weld joint geometry is disclosed in U.S. Pat. No. 4,164,311 to Swisher Sr. issued Aug. 14, 1979. The disclosed joint construction appears to use a beveled base. The reference advocates a relatively small angle on the order of about 10 degrees between the beveled base and a plane drawn through the bottom of the land or keel. Welds produced using prior joint geometries have been generally useful. However, in applying welds to heavy gauge materials it often has been difficult to form full-penetration welds without introducing discontinuities during the initial weld formation process. The occurrence of such discontinuities requires a so-called “back-gouging” procedure in which the discontinuities are removed by localized heating. Such back-gouging procedures add substantial heat to the weld joints and may lead to distortion. Back-gouging may also lead to substantial noise and debris as molten material is removed from the weld joint.

Accordingly, an improved weld joint for use in forming full-penetration welds without the need for substantial back-gouging is desirable.

### SUMMARY

In accordance with one aspect, the present disclosure provides a weld joint adapted to facilitate butt-welding attachment of a first structure to a second structure. The weld joint includes a first J groove disposed across a first side of the weld joint and a second J groove disposed across a second side of the weld joint opposing the first side. The first J groove and the second J groove may each include a weld-support surface defined by a land-projection segment extending away from an intersection of chamfered groove faces across the first structure. The first J groove and the second J groove may each further include an angled edge boundary defined by the chamfered groove faces of the first structure. The chamfered groove faces extend in angled relation away from the land-projection segment.

In accordance with another aspect, the present disclosure provides a method of butt-welding a first structure to a second structure. The method includes forming a first structure interface including a substantially planar land-projection segment extending outwardly from an angled face of the first structure. The land-projection segment includes a first weld support surface, a second weld support surface facing away from the first weld support surface, and a substantially planar distal edge portion. The angled face includes a first chamfered groove face extending in angled relation away from the first weld support surface. The angled face also includes a second chamfered groove face extending in angled relation away from the second weld support surface. The distal edge portion is abutted against a second structure interface including a substantially planar engagement surface adapted for abutting engagement with the distal edge portion to define a double-sided weld joint having a substantially K-shaped profile. Connective welds are applied along the weld joint.

### BRIEF DESCRIPTION OF THE DRAWINGS

FIG. 1 is a diagrammatic perspective view of two plate structures arranged in abutting relation for butt welding.

FIG. 2 is an elevation diagrammatic view illustrating the weld joint between the structures of FIG. 1.

FIG. 3 is a view similar to FIG. 2 illustrating the weld joint in filled condition following welding joinder.

FIG. 4 is an exploded diagrammatic view similar to FIG. 2.

### DETAILED DESCRIPTION

This disclosure relates to an improved weld joint for a butt-welded connection between structures. A planar land-projection segment defining a weld support surface projects away from an angled face across one of the structures. A distal end of the land-projection segment defining a land surface engages an opposing, substantially planar surface of the other structure to define a substantially K-shaped joint profile.

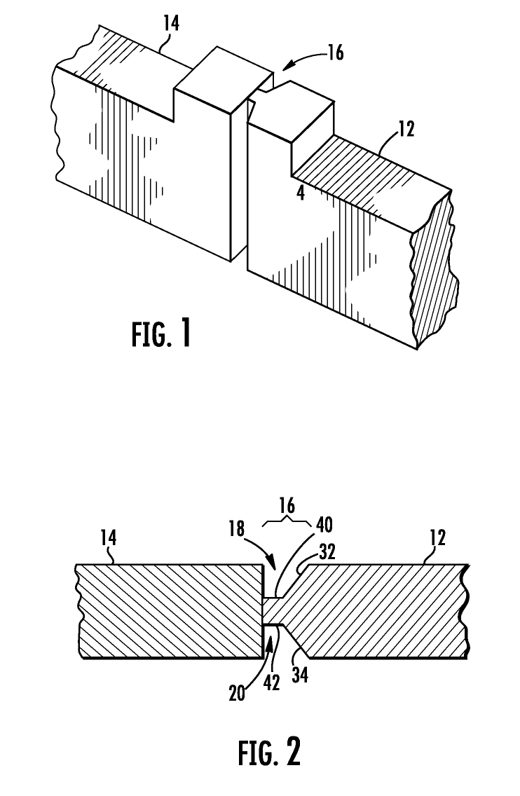

Reference will now be made to the drawings wherein, to the extent possible, like elements are designated by like reference numerals throughout the various views. FIG. 1 illustrates an exemplary abutment arrangement for welding attachment between a first structure 12 and a second structure 14. By way of example only, and not limitation, the first structure 12 and/or the second structure 14 may be a plate or the like although other constructions may likewise be utilized if desired. According to one contemplated practice, the first structure 12 and/or the second structure 14 may be made of metal although other materials such as polymers, composites and the like may also be used. By way of example only, and not limitation, according to one exemplary practice, each of the first structure 12 and a second structure 14 may be structural steel plates characterized by a substantial thickness of about 12 millimeters or greater, and typically about 30 millimeters or greater.

As illustrated through joint reference to FIGS. 1 and 2, in the abutting relationship, the first structure 12 and the second structure 14 cooperatively define a weld joint 16 extending along the junction between the first structure 12 and the second structure 14. As best seen in FIG. 2, in the exemplary construction, the weld joint 16 is a double-sided joint characterized by a generally K-shaped cross-sectional profile. In this regard, the exemplary weld joint 16 includes a first weld cavity 18 in the form of a so-called “J Groove” disposed at a first side of the weld joint 16 and a second weld cavity 20 in the form of a J Groove disposed at a second side of the weld joint 16.

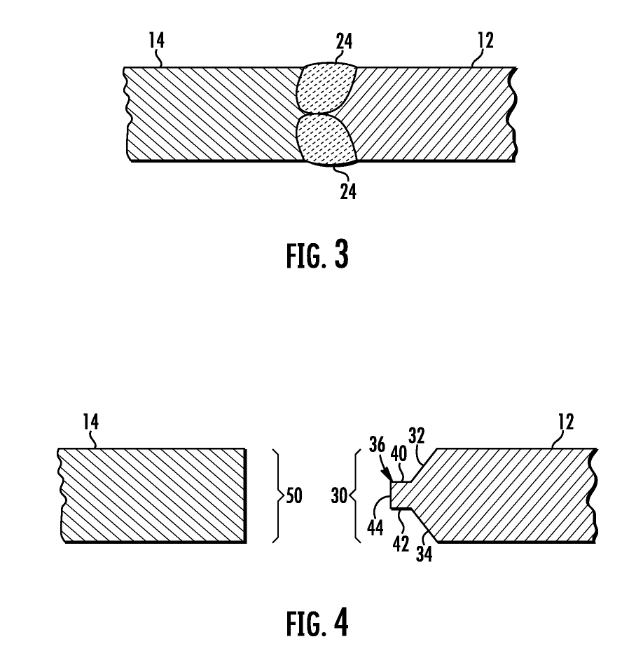

As illustrated in FIG. 3, the first weld cavity 18 and the second weld cavity 20 are each adapted to receive filler material 24 during a welding process to form a secure connection between the first structure 12 and the second structure 14. As will be appreciated, the weld connection illustrated in FIG. 3 is a full penetration weld, with portions of the first structure 12 and the second structure 14 along the weld joint 16 having been melted and blended with the filler material 24 to form a fully welded interface between the first structure 12 and the second structure 14.

Referring to FIG. 4, in the exemplary construction, the first structure 12 defines a first structure joint interface 30 including a first chamfered groove face 32 and a second chamfered groove face 34. The first structure joint interface 30 also includes a land-projection segment 36, commonly referred to as a “Flat” projecting away from the angled face structure generally at an intersection formed by the first chamfered groove face 32 and a second chamfered-groove face 34. The land-projection segment 36 defines a first weld support surface 40 and a second weld support surface 42. The first weld support surface 40 and the second weld support surface 42 provide support bases for the filler material 24. In the illustrated construction, the first weld support surface 40 and the second weld support surface 42 are generally flat, although other surface geometries may likewise be utilized if desired. The land-projection segment 36 also includes a distal edge portion 44 defining the so-called “Land” or “Root Face” of the weld joint 16. In the illustrated construction, the distal edge portion 44 is substantially planar and is oriented generally perpendicular to the planes defined by the first weld support surface 40 and the second weld support surface 42.

In the illustrated exemplary construction, the first chamfered groove face 32 extends in angled relation away from the first weld support surface 40 and the second chamfered groove face 34 extends in angled relation away from the second weld support surface 42. The angle between the first chamfered groove face 32 and the first weld support surface 40 may be substantially equivalent to the angle between the second chamfered groove face 34 and the second weld support surface 40 although different angles also may be used if desired. Regardless of the angles utilized, the first weld support surface 40 and the first chamfered groove face 32 cooperatively define boundaries of the “J” groove configuration of the first weld cavity 18. Likewise, the second weld support surface 42 and the second chamfered groove face 34 cooperatively define boundaries of the “J” groove configuration of the second weld cavity 20.

By way of example only, and not limitation, in one exemplary construction the first chamfered groove face 32 and the second chamfered groove face 34 may each be oriented at an angle of about 15 to about 45 degrees, and typically about 30 degrees, relative to a plane at the base of the land-projection segment 36 oriented substantially perpendicular to the first weld support surface 40 and the second weld support surface 42 respectively. Thus, the first chamfered groove face 32 and the second chamfered groove face 34 may each be oriented at an angle of about 105 to about 135 degrees and typically about 120 degrees relative to the first weld support surface 40 and the second weld support surface 42 respectively.

As illustrated, the second structure 14 presents a second structure joint interface 50 adapted to abuttingly engage the substantially planar distal edge portion 44 of the land-projection segment 36. In the exemplary construction which is illustrated, the second structure joint interface 50 is substantially planar and is oriented generally perpendicular to the planes defined by the first weld support surface 40 and the second weld support surface 42. Thus, the distal edge portion 44 of the land-projection segment 36 may seat against the second structure joint interface 50.

In one exemplary construction, the first weld support surface 40 and the second weld support surface 42 of the land-projection segment 36 may be approximately 5 millimeters in length with the distal edge portion 44 being about 5 millimeters in thickness. According to another exemplary construction, the first weld support surface 40 and the second weld support surface 42 may have a length of approximately 7 millimeters and the distal edge portion 44 may have a thickness of about 3 millimeters. According to yet another exemplary construction, the first weld support surface 40 and the second weld support surface 42 may have a length of approximately 7 millimeters and the distal edge portion 44 may have a thickness of about 30 millimeters. Of course, these dimensions are exemplary only and may be adjusted as desired. By way of example only, in some instances it may be useful to increase the thickness of the distal edge portion 44 for use in high-heat penetration welds.

An exemplary process for butt-welding a first structure 12 to a second structure 14 along a weld joint 16 as previously described may be carried out by machining a first structure joint interface 30 and a second structure joint interface 50 as previously described such that the first structure joint interface 30 includes a land-projection segment 36 projecting away from the first chamfered groove face 32 and the second chamfered groove face 34 with the second structure joint interface 50 being substantially planar. Following machining, the distal edge portion 44 of the land-projection segment 36 may be abutted against the second structure joint interface 50 to establish an orientation substantially as illustrated in FIG. 2. In this flush abutting relation, tack welds (not shown) may be applied at positions along the length of the weld joint 16 to hold the relative position of the structures. Thereafter, alternating weld passes may be applied along each side of the weld joint 16. Applying welds using alternating passes on opposing sides of the weld joint 16 may be helpful in reducing any distortion. As will be appreciated through joint reference to FIGS. 2-4, during the welding process the material forming the land-projection segment 36 and adjacent portions of the first structure 12 and the second structure 14 may undergo substantially complete melting and become integral with the applied filler material 24 to form a full penetration weld defining a substantially continuous connection between first structure 12 and the second structure 14.

### INDUSTRIAL APPLICABILITY

Connections using weld joints consistent with the present disclosure may find application in a number of environments. Such connections may be particularly well adapted for use in the fabrication of equipment and structural elements using relatively thick gauge metal plate elements.

In practice, connections using weld joints consistent with this disclosure may be used in the fabrication of heavy industrial equipment, transportation vehicles and the like incorporating adjoined panels of heavy gauge steel or other structural material. In such environments of use, the substantially K-shaped joint may provide secure connective attachment while reducing the occurrence of discontinuities that may require removal by use of a back-gouging procedure.

It will be appreciated that the foregoing description provides examples of the disclosed system and technique. However, it is contemplated that other implementations of the disclosure may differ in detail from the foregoing examples. All references to examples herein are intended to reference the particular example being discussed at that point and are not intended to imply any limitation as to the scope of the disclosure or claims more generally. All language of distinction and disparagement with respect to certain features is intended to indicate a lack of preference for those features, but not to exclude such from the scope of the claims entirely unless otherwise indicated.

Accordingly, this disclosure contemplates the inclusion of all modifications and equivalents of the subject matter recited in the appended claims as permitted by applicable law. Moreover, any combination of the above-described elements in all possible variations thereof is contemplated unless otherwise indicated herein or otherwise clearly contradicted by context.

What is claimed is:

1. A weld joint adapted to facilitate butt-welding attachment of a first structure to a second structure, the weld joint comprising:
a first weld accepting J groove disposed across a first side of the weld joint; and
a second weld accepting J groove disposed across a second side of the weld joint opposing said first side, wherein each of the first weld accepting J groove and the second weld accepting J groove includes a substantially flat weld support surface defined by a substantially planar land-projection segment extending away from said first structure, and wherein each of the first weld accepting J groove and the second weld accepting J groove further includes an angled face boundary defined by a chamfered groove face extending in angled relation away from said land-projection segment at an angle of about 105 to about 135 degrees relative to said land-projection segment.

2. A weld joint as recited in claim 1, wherein at least one of said first structure and said second structure is a plate having a thickness of about 12 millimeters or greater.

3. A weld joint as recited in claim 1, wherein at least one of said first structure and said second structure is a steel plate having a thickness of about 30 millimeters or greater.

4. A weld joint as recited in claim 1, wherein each of said first structure and said second structure is a plate having a thickness of about 12 millimeters or greater.

5. A weld joint as recited in claim 1, wherein each of said first structure and said second structure is a steel plate having a thickness of about 30 millimeters or greater.

6. A weld joint as recited in claim 1, wherein said land-projection segment includes a substantially planar distal edge portion including a thickness dimension extending between said first weld accepting J groove and said second weld accepting J groove.

7. A weld joint as recited in claim 6, wherein said thickness dimension of said distal edge portion is substantially equivalent to a length dimension of said land-projection segment extending between the distal-edge portion and the chamfered groove face.

8. A weld joint as recited in claim 7, wherein said thickness dimension of said distal edge portion is about 5 millimeters and said length dimension of said land-projection segment is about 5 millimeters.

9. A weld joint as recited in claim 6, wherein said thickness dimension of said distal edge portion is less than a length dimension of said land-projection segment extending between said distal edge portion and said chamfered groove face.

10. A weld joint as recited in claim 9, wherein said thickness dimension of said distal edge portion is about 3 millimeters and said length dimension of said land-projection segment is about 7 millimeters.

11. A weld joint adapted to facilitate butt-welding attachment of a first structure to a second structure, the weld joint comprising:
a first structure interface including a substantially planar land-projection segment extending outwardly from an angled face of said first structure, said land-projection segment including a first weld support surface, a second weld support surface facing away from said first weld support surface, and a distal edge portion, said angled face including a first chamfered groove face extending in angled relation away from said first weld support surface at an angle of about 105 to about 135 degrees relative to said first weld support surface, and said angled face including a second chamfered groove face extending in angled relation away from said second weld support surface at an angle of about 105 to about 135 degrees relative to said second weld support surface; and
a second structure interface including a substantially planar engagement surface adapted for abutting engagement with said distal edge portion, such that abutting engagement of said distal edge portion with said substantially planar engagement surface defines a weld joint having a substantially K-shaped profile.

12. A weld joint as recited in claim 11, wherein at least one of said first structure and said second structure is a steel plate having a thickness of about 30 millimeters or greater.

13. A weld joint as recited in claim 11, wherein each of said first structure and said second structure is a steel plate having a thickness of about 30 millimeters or greater.

14. A weld joint as recited in claim 11, wherein said distal edge portion is substantially planar including a thickness dimension extending between the first weld support surface and the second weld support surface.

15. A weld joint as recited in claim 14, wherein said thickness dimension of said distal edge portion is substantially equivalent to a length dimension of said land-projection segment extending between said distal edge portion and said angled face of said first structure.

16. A weld joint as recited in claim 15, wherein said thickness dimension of said distal edge portion is about 5 millimeters and said length dimension of said land-projection segment is about 5 millimeters.

17. A weld joint as recited in claim 14, wherein said thickness dimension of said distal edge portion is less than a length dimension of said land-projection segment extending between said distal edge portion and said angled face of said first structure.

18. A weld joint as recited in claim 17, wherein said thickness dimension of said distal edge portion is about 3 millimeters and said length dimension of said land-projection segment is about 7 millimeters.

19. A method of forming a butt-weld between a first structure and a second structure, the method comprising the steps of:
(a) forming a first structure interface including a substantially planar land-projection segment extending outwardly from an angled face of said first structure, said land-projection segment including a first weld support surface, a second weld support surface facing away from said first weld support surface, and a substantially planar distal edge portion, said angled face including a first chamfered groove face extending in angled relation away from said first weld support surface at an angle of about 105 to about 135 degrees relative to said first weld support surface, and said angled face including a second chamfered groove face extending in angled relation away from said second weld support surface at an angle of about 105 to about 135 degrees relative to said second weld support surface;
(b) abutting said distal edge portion against a second structure interface including a substantially planar engagement surface adapted for abutting engagement with said distal edge portion, such that abutting engagement of said distal edge portion with said substantially planar engagement surface defines a double-sided weld joint having a substantially K-shaped profile; and
(c) applying connective welds along said weld joint.

20. The method as recited in claim 19, wherein the connective welds are applied using alternating weld passes along each side of the weld joint.
